(19) United States
(12) Patent Application Publication
(10) Pub. No.: US 2002/0115798 A1
(43) Pub. Date: Aug. 22, 2002

(54) Star-branched anionic polymers

(76) Inventors: Sridevi Narayan-Sarathy, Hilliard, OH (US); Laurence G. Dammann, Powell, OH (US)

Correspondence Address: David L. Hedden, ASHLAND INC., P.O. Box 2219, Columbus, OH, 43216, US

(21) Appl. No.: 09/742,713

(22) Filed: Dec. 20, 2000

(51) Int. Cl. C08F 2/00

(52) U.S. Cl. 525/261; 528/376; 528/374; 528/375

(57) ABSTRACT

This invention relates to star-branched anionic acrylate polymers synthesized by the free radical polymerization of a monomer(s) containing anionic functionality in the presence of chain-transfer agents containing multiple mercapto groups.

### FIELD OF THE INVENTION

This invention relates to star-branched anionic polymers synthesized by the free radical polymerization of vinyl monomer(s) containing anionic functionality in the presence of a chain-transfer agent having multiple mercapto groups.

### BACKGROUND OF THE INVENTION

Star-branched acrylate and methacrylate polymers, obtained by the anionic polymerization of at least one unsaturated acrylate or methacrylate ester of a polyol (which forms the core of the star-branched polymer) and at least one acrylic or methacrylic monomer (which forms the arm(s) of the star-branched polymer), are described in U.S. Pat. No. 5,552,491. The synthesis is carried out in the absence of moisture, oxygen, and impurities at very low temperatures.

U.S. Pat. Nos. 4,659,782; 4,659,607; 4,794,144; 4,810,756; and 4,847,328 disclose the synthesis of acrylic star-branched polymers by group transfer polymerization (GTP). In this process, arms of star polymers are prepared by the polymerization of vinyl polymers initiated by certain initiators of the formula Q-Z, where Z is an activating substituent that becomes attached to one end of the growing polymer molecule, and where Q is a group that continuously transfers to the other end of the growing polymer molecule as more monomer is added. Q is thus an active site that can initiate further polymerization and a “living polymer” is produced. The resulting “living polymer” is then quenched with active hydrogen containing compound and then reacted by a condensation reaction of the functional groups in the arms, with or without other monomers, to form a cross-linked core of the star. The cross-linked cores are obtained by condensation reactions involving the functional groups on the arms.

Multifunctional initiators (See U.S. Pat. No. 4,508,880) and capping agents having more than one reactive site (See U.S. Pat. No. 4,524,196) are also used in the preparation of acrylic star polymers via anionic polymerization. These are polydispersed materials, which increase in molecular weight and viscosity on storage.

### SUMMARY OF THE INVENTION

This invention relates to star-branched anionic polymers having a structural formula selected from the group consisting of:

C—[CH₂OCOCH₂CH₂S˜˜˜polymer]ₓ, (1)

where x=4;

R-C—[CH₂OCOCH₂Ch₂S˜˜˜polymer]ₓ, (2)

where x=3 and R=H, C₁₋₄ alkyl, or phenyl;

polymer˜˜˜SCH₂OCOCH₂CH₂OCOCH₂S˜˜˜polymer, and (3)

mixtures thereof, (4)

and “˜˜˜polymer” or “polymers˜˜˜” is a homopolymer or copolymer segment derived from one or more monomers that form an anionic polymeric segment, preferably (meth) acrylic acid, and said segment has an average molecular weight of ˜500 to ˜5,000 as determined by gas permeation chromatography (GPC).

The subject polymers differ from star-branched acrylate polymers because they are formed by free radical polymerization using multifunctional chain transfer agents, rather than group-transfer polymerization or the anionic polymerization of multifunctional initiators.

The subject polymers have lower viscosity than analogous linear polymers based on acrylic acid. Consequently, less water is needed to dilute them for shipping and use. As a result, scale inhibitors with more polymer per hundred parts of solution can be formulated. Since these formulations have more active polymer on a weight basis, they are more cost-effective as scale inhibitors.

The polymers are useful as scale inhibitors for cooling water towers and boilers. Inhibition of scale build-up in cooling water towers and boilers is important for maintaining efficient operation of these systems. Scale build-up caused primarily by calcium, magnesium, and iron salt deposits, are effectively inhibited by the polymers of this invention.

The polymers are also useful as pigment dispersants in water-based coating and adhesive formulations. Dispersants are necessary in the formulations to keep the pigment suspended for good storage stability, to achieve good application properties and produce desirable appearance properties in the coated film (i.e. surface smoothing, gloss etc.).

There are advantages to the synthesis of star-shaped anionic polymers by the above-described free-radical procedure over GTP and anionic methods. GTP requires (1) a nucleophilic or Lewis acid catalyst, which is a disadvantage in terms of purification; (2) organic solvents; and (3) higher reaction temperatures. The disadvantages of anionic polymerization are: (1) anionic polymerization requires low temperatures (below ambient temperature; (2) there are competitive side reactions that reduce the yield of the desired product; (3) the reaction must take place in the absence of water or oxygen; and (4) only hydrocarbon solvents can be used.

### BEST MODE AND OTHER MODES

The star-branched anionic polymers have a core and branches. They are prepared by the by free radical polymerization of a vinyl monomer containing anionic functionality in the presence of a multi-functional chain transfer agent. The core of the star-branched anionic polymer is generated by a chain-transfer agent, containing multiple —SH groups. The source of the branches of the star-branched anionic polymer is a vinyl monomer containing anionic functionality.

Two-armed star-branched polymers are obtained by using chain transfer agents containing 2 —SH groups, particularly ethylene glycol (bis thioglycolate). Three-armed star polymers are obtained by using a chain transfer agent from the group consisting of trimethylol propane (tris-3-mercapto propionate) and other chemicals containing 3 —SH groups. Four-armed star-branched polymers are obtained by using chain transfer agents selected from the group consisting of pentaerythritol tetrakis (3-mercapto propionate) and other chemicals containing 4 —SH groups.

The arms of the star-branched anionic polymer are generated, by reacting the chain transfer agent with a water-soluble monomer vinyl monomer containing anionic functionality in water (aqueous polymerization). Representative examples of such monomers include acrylic acid, methacrylic acid, 2-acrylamidomethyl propane sulfonic acid (AMPS), itaconic acid, acrylamide and p-styrene sulfonic acid. The average molecular weight of the arms of the star-shaped polymer is from ˜500 to ˜5,000 as determined by gas permeation chromatography (GPC).

The reaction takes place in the presence of a free radical initiator. Representative examples of free radical initiators that can be used include Ammonium persulfate, Potassium persulfate, redox initiators and water-soluble azo initiators. Ammonium persulfate is the preferred initiator. The reaction is carried out under aqueous polymerization conditions. Typically, the amount of solvent used is three times the weight of the total amount of monomers. Reaction temperatures are typically from room temperature to 100° C., preferably at about 80° C. Preferably, the reaction is carried out by the continuous and independent addition of the chain transfer agent, monomer, and initiator. For the synthesis of low molecular weight polymers, a large amount of initiator needs to be present in the reactor at the beginning of the reaction. At the end of the reaction, the polymer is usually converted to its corresponding alkali metal or ammonium salt, so that it is completely soluble in water and the carboxyl ions are freely available for scale inhibition. Other monomers can be co-polymerized with the monomers used to form the arms of the star-shaped polymer. Co-monomers used in the aqueous polymerization method are preferably water-soluble or soluble in acrylic acid and include methacrylic acid, AMPS, acrylamide, N,N-dimethylacrylamide, HEA and HPA.

The synthesis can also be carried out by precipitation polymerization using an organic solvent, e.g. toluene, and an azo initiator. Examples of azo initiators include azobis(isobutyro nitrile) and 2,2′-azobis(2-methylbutane) nitrile. In this case, the resulting star-branched polymer is not converted to its salt at the end of the reaction, but is converted to sodium salt after dispersing the polymer in water. The precipitation polymerization is a less desirable process because an organic solvent is used. However, this method is useful for the co-polymerization of acrylic acid with hydrophobic monomers and also when high concentrations of a chain transfer agent are used to synthesize the polymer. Such comonomers include methyl methacrylate, ethyl acrylate, ethyl methacrylate, butyl acrylate, butyl methacrylate, isobutyl acrylate, isobutyl methacrylate, t-butyl acrylate, t-butyl methacrylate, propyl methacrylate, 2-hexylethyl acrylate, 2-ethyl hexyl methacrylate, hexyl acrylate, hexyl methacrylate, isopropyl methacrylate, lauryl acrylate, lauryl methacrylate, stearyl acrylate and stearyl methacrylate.

The amount of chain-transfer agent is varied depending on the molecular weight requirement. It is desirable to react all the —SH group of the monomer to avoid odor problems. However, typically the unreacted —SH groups for three star-shaped monomer is from 10-15%; for four star-shaped monomer is from 15-20%; and for five star-shaped monomer is from 45-55%, where said percentages are determined by NMR analysis.

The amount of catalyst used is typically 0.5 to 2.0 gram of initiator per 100 grams of monomer.

When the star-shaped polymers are used as calcium scale inhibitors, they may be typically combined with other known components. For some applications it is preferable to add a water-soluble copolymer to the scale inhibiting composition like phosphinocarboxylic polymer, maleic acid or maleic anhydride polymer, acrylic polymer, methacrylic polymer and their copolymers with sulfonic and/or phosphino functionalities, preferably acrylic/sulfonic copolymers or acrylic/maleic copolymers. Other optional components include phosphonobutane tricarboxylic acid, tolyltriazole, orthophosphate, polyphosphates, hydroxyethylidene diphosphonic acid, amino tri (methylene phosphonic acid).

The star-shaped polymers can also be used as pigment dispersants, particularly for pigments that are dispersed in water. Pigments that can be used in the pigment dispersion composition include organic and inorganic pigments. Examples of organic pigments include condensed polycyclic pigments such as quinacridone-type, perinone-type, perylene-type, dioxazine-type, isoindolinone-type, isoindolin-type, quinophthalone-type, anthraquinone-type, pyrrolopyrrole-type, diketopyrrolopyrrol-type, thioindigo-type and metal complex-type pigments, phthalocyanine-type pigments, and pigments of condensed azo-based compounds and derivatives thereof. Examples of inorganic pigments include carbon black, titanium oxide and silicon dioxide. The pigment dispersion may include other well-known components in addition to water, the pigment, and the star-shaped polymer.

### EXAMPLES

The specific examples are merely illustrative of the invention, and are not intended to restrict the scope of the invention.

### Example 1

### Synthesis of a star polymer having two branches based on ethylene glycol (bis thioglycolate) and acrylic acid

Two hundred and twenty grams of deionized water were added to a 4-neck, 1 liter reaction vessel equipped with a condenser, mechanical stirrer, thermocouple, nitrogen sparge tube, three addition funnels connected to metering pumps, and nitrogen inlet/outlet. The water was heated to 80° C. with constant nitrogen sparging over 30 minutes. In the meanwhile, 0.15 g of ammonium persulfate (as the free radical initiator) in 10 ml water was added to one of the three addition funnels, 7.91 grams of ethylene glycol (bis thioglycolate), as the chain-transfer agent, dispersed in 10 ml of acetone, was added to the second addition funnel, and 92.1 grams of acrylic acid (as the monomer) was added to the third addition funnel.

After sparging, the nitrogen sparge was switched to a nitrogen sweep and 0.5 gram ammonium persulfate dissolved in 2-ml water added to reactor. Then the addition of the three components from the fimnels began started and they were added independently and continuously over a period of 1 hour. All three addition funnels were rinsed with 10-ml water each.

After completion of addition, the reaction was maintained at 80° C. for 15 minutes and 0.1 gram of ammonium persulfate in 2 ml of water was added to reactor. The reaction was stirred for 2 hours at 80° C. and 0.2 g sodium bisulfite is added to scavenge unreacted initiator. The reaction mixture was stirred at 80° C. for another hour and then cooled down to 40° C. Then 50 grams of sodium hydroxide in 50 ml water was slowly added to reactor maintaining temperature at 40° C.

A clear solution was obtained at the end of the reaction. Part of the aqueous solution was poured into acetone to precipitate the solid polymer. Re-precipitation was conducted to obtain a clean polymer, which was dried in the vacuum oven overnight at 80° C. Detailed NMR studies of the solid polymer indicate the formation of about 50% of the 2-armed species.

### Example 2

### Synthesis of a star polymer having three branches based on trimethylol propane (tris-3-mercapto propionate) and acrylic acid

The reaction was conducted in a similar manner as Example 1, but the chain-transfer agent used in this case was 10 g of trimethylol propane (tris-3-mercapto propionate) and 90 g of acrylic acid. An opaque solution was formed from the beginning of the reaction and continued even after the addition of sodium hydroxide.

Detailed NMR studies of the solid polymer indicates the formation of predominantly 3-armed star polymer (about 82% of the 3-armed species with some amount of 2-armed and linear species).

### Example 3

### Synthesis of a star polymer having four branches based on pentaerythritol tetrakis (3-mercapto propionate) and acrylic acid

The reaction was conducted in a similar manner as Example 1, but the chain-transfer agent used in this case was 8.1 g of pentaerythritol tetrakis (3-mercapto propionate) and 91.9 g of acrylic acid. A slightly opaque solution was obtained at the end of the reaction. After the addition of sodium hydroxide, precipitation, and drying, detailed ¹³C NMR confirmed the formation of predominantly 4-armed star polymer (about 87% of stars existing as 4-armed species).

### Example 4

### Synthesis of a star polymer having four branches based on pentaerythritol tetrakis (3-mercapto propionate), acrylic acid, and AMPS

The reaction was conducted in a similar manner as Example 1, but a mixture of monomers used consisting of 17.7 g of AMPS pre-dissolved in 20-ml deionized water and 70.8 g acrylic acid. A slightly opaque solution obtained at the end of reaction. Measurements using a Brookfield Viscometer showed the viscosity of aqueous solution to be around 37.0 centipoise. After the addition of sodium hydroxide, re-precipitation, and drying, detailed ¹³C NMR confirmed the formation of predominantly 4-armed star copolymer.

### Example 5

### Synthesis of a star polymer having four branches based on pentaerythritol tetrakis (3-mercapto propionate), acrylic acid, and itaconic acid

The reaction was conducted in a similar manner as Example 1, but 17.7 g of itaconic acid dissolved in 220 g deionized were added to the reaction vessel. The monomer used was a mixture of 17.7 g of itaconic acid pre-dissolved in 20-ml deionized water and mixed with 70.8 g acrylic acid. A slightly opaque solution obtained at the end of reaction. Measurements using a Brookfield Viscometer showed the viscosity of aqueous solution to be around 37.0 centipoise. After the addition of sodium hydroxide, re-precipitation, and drying, detailed ¹³C NMR confirmed the formation of predominantly 4-armed star copolymer.

### Example 6

### Synthesis of a star polymer having four branches based on pentaerythritol tetrakis (3-mercapto propionate) and acrylic acid by precipitation polymerization

Two hundred and fifty grams of toluene was added to a 4-neck, one liter reaction vessel equipped with a condenser, mechanical stirrer, thermocouple, 3 addition fimnels connected to metering pumps and a nitrogen inlet/outlet. The toluene was heated to 80° C. over a period of 15 minutes under constant nitrogen sweep. Meanwhile, 0.13 g of VAZO-67 [2,2′-azobis(2-methylbutane nitrile] in 10 ml toluene, 10 grams of pentaerythritol tetrakis (3-mercapto propionate) mixed with 20 ml toluene, and 90 grams of acrylic acid were each added to a separate addition finnel. At the end of the period, 0.43-gram initiator was dissolved in 4-ml toluene and added to reaction vessel. The three components were then added continuously over a period of 2 hours. Each of the three addition funnels was then rinsed with 10 ml toluene. After completion of addition, reaction was stirred for another 2 hours at 80° C. 0.086 gram of initiator was added to the reactor and the reaction was stirred at 90° C. for another hour. The reaction was cooled down to room temperature and an almost gel-like solid product was obtained. This product was removed from the reactor and filtered using Buchner funnel with some difficulty. The final polymer, a solid, was dried in the vacuum oven overnight at 80° C. Detailed ¹³C NMR confirmed the formation of 4-armed star polymer.

Test of star-shaped polymers as calcium carbonate inhibitors The star-shaped polymer of Example 3 was tested to determine its effectiveness as a calcium carbonate inhibitor. The test method is described as follows and the test results are set forth in Table I:

Scale inhibition for the star-shaped polymer of Example 3 was evaluated with the standard tube-blocking test. The dynamic test used, commonly known as tube blocking test, is based on monitoring the increase in pressure resulting from scaling inside a capillary stainless steel tube, as a supersaturated solution is pumped through.

The solution had the following composition: 600 ppm calcium as CaCO3, 300 ppm Mg as CaCO3, 600 ppm alkalinity as CaCO3, 288 ppm sulfate. The pH was 8.6 and the temperature 82° C. The column was 1 m in length and 1 mm internal diameter. The flow rate was 10 mL / min. The test duration was 50 min. The effect of scale control treatments is measured by determining the percent inhibition, defined here as a relative slope pressure/time [(slope untreated—slope test)/slope untreated×100 )] and the minimum dose required to obtain 100% inhibition (no detectable pressure increase). In addition, the time at which a first departure from the initial pressure occurs (“induction time”) is noted. In order to account for small differences in the response of the system at different times, due to slight variations in solution composition or the condition of the scaling surface (column), a reference material was always included in a set of tests. The reference material was hydroxyethylidene diphosphonic acid (HEDP), for which the normal minimum dose was 1.6 ppm. The actual range of the minimum dose for HEDP at different times was 1.1-1.6 ppm. All doses reported have been corrected proportionally to the reference response with respect to the normal value: reported dose=actual dose/HEDP minimum dose×1.6

TABLE I
(Inhibition of calcium carbonate scale by 4-armed star polyacrylic acid)

| Dosage (ppm) | % Inhibition |
|---|---|
| 3 | 95.4 |
| 4 | 96.6 |
| 5 | 97.1 |
| 6 | 97.4 |
| 7 | 98.5 |
| 8 | 98.5 |

Test of star-shaped polymers as pigment dispersant The star-shaped polymer of Example 3 was tested to determine its effectiveness as a pigment dispersant. The test method is described as follows and the results are set forth in Table II:

A 70% aqueous dispersion of titanium dioxide is mixed with 0.1% of test dispersant and the Brookfield viscosity measured. About 0.5 ml of a 10% dispersant solution prepared with the star polymer is added. Test solution is thoroughly mixed using a dispersator and viscosity measured. Test is repeated until viscosity is constant.

TABLE II
(4-armed star poly (acrylic acid) as pigment dispersants)

| Polymer Concentration | |
|---|---|
| (wt/wt TiO₂) | Slurry Viscosity (cps) |
| 0.07 | 20000 |
| 0.14 | 3200 |
| 0.21 | 2800 |
| 0.28 | 1200 |
| 0.35 | 1200 |
| 0.42 | 800 |
| 0.49 | 1000 |
| 0.7 | 600 |
| 1.12 | 400 |

The data in Table II indicate that the star-shaped polymer is effectively dispersing the TiO₂ pigment.

We claim:

1. A multifunctional star-branched anionic polymer having a structural formula selected from the group consisting of:
C—[CH₂OCOCH₂Ch₂S˜˜˜polymer]ₓ, (1)
where x=4;
R-C—[CH₂OCOCH₂CH₂S˜˜˜polymer]ₓ, (2)
where x=3 and R=H, C₁₋₄ alkyl, or phenyl;
polymer˜˜˜SCH₂OCOCH₂CH₂OCOCH₂S˜˜˜polymer, and (3)
mixtures thereof, (4)
and “˜˜˜polymer” or “polymer˜˜˜” is a homopolymer or copolymer segment derived from one or more monomers that form an anionic polymeric segment, preferably (meth) acrylic acid, and said segment has an average molecular weight of ˜500 to ˜5,000 as determined by gas permeation chromatography.

2. The polymer of claim 1 wherein the chain transfer agent is glycol (bis thioglycolate).

3. The polymer of claim 1 wherein the chain transfer agent is trimethylol propane (tris-3-mercapto propionate).

4. The polymer of claim 1 wherein the chain transfer agent is pentaerythritol tetrakis (3-mercapto propionate).

5. The polymer of claim 1, 2, 3, or 4 wherein the monomer is selected from the group consisting of acrylic acid, methacrylic acid, 2-acrylamidomethyl propane sulfonic acid, itaconic acid, acrylamide and p-styrene sulfonic acid.

6. The polymer of claim 5 wherein the monomer also contains a monomer selected from the group consisting of methyl methacrylate, ethyl acrylate, ethyl methacrylate, butyl acrylate, butyl methacrylate, isobutyl acrylate, isobutyl methacrylate, t-butyl acrylate, t-butyl methacrylate, propyl methacrylate, 2-hexylethyl acrylate, 2-ethyl hexyl methacrylate, hexyl acrylate, hexyl methacrylate, isopropyl methacrylate, lauryl acrylate, lauryl methacrylate, stearyl acrylate, stearyl methacrylate, and mixtures thereof.

7. A process for preparing a star-branched anionic polymer comprising reacting a multifunctional thio compound with a monomer containing anionic functionality in the presence of a free radical initiator under aqueous conditions.

8. The process of claim 8 which comprises the additional step of neutralizing with an alkali metal hydroxide or ammonium hydroxide.

9. The process of claim 8 wherein the multifunctional thio compound is selected from the group consisting of glycol (bis thioglycolate), trimethylol propane (tris-3-mercapto propionate), pentaerythritol tetrakis (3-mercapto propionate), and mixtures thereof.

10. The process of claim 9 wherein the monomer is selected from the group consisting of acrylic acid, methacrylic acid, 2-acrylamidomethyl propane sulfonic acid, itaconic acid, acrylamide and p-styrene sulfonic acid.

11. The process of claim 10 wherein the reaction is carried out above ambient temperature.

12. The process of claim 11 wherein the free radical initiator is ammonium persulfate.

13. The process of claim 12 wherein the multifunctional thio compound, monomer, and free radical initiator are added continuously to the reaction vessel.

14. A process for preparing a star-branched anionic polymer comprising reacting a multifunctional thio compound with a monomer containing anionic functionality in the presence of an azo compound and an organic solvent.

15. The process of claim 14 which comprises the additional step of dispersing the polymer in water and neutralizing with an alkali metal hydroxide or ammonium hydroxide.

16. The process of claim 15 wherein the multifunctional thio compound is selected from the group consisting of glycol (bis thioglycolate), trimethylol propane (tris-3-mercapto propionate), pentaerythritol tetrakis (3-mercapto propionate), and mixtures thereof.

17. The process of claim 16 wherein the monomer is selected from the group consisting of acrylic acid, methacrylic acid, 2-acrylamidomethyl propane sulfonic acid, itaconic acid, acrylamide and p-styrene sulfonic acid and as co-monomers methyl methacrylate, ethyl acrylate, ethyl methacrylate, butyl acrylate, butyl methacrylate, isobutyl acrylate, isobutyl methacrylate, t-butyl acrylate, t-butyl methacrylate, propyl methacrylate, 2-hexylethyl acrylate, 2-ethyl hexyl methacrylate, hexyl acrylate, hexyl methacrylate, isopropyl methacrylate, lauryl acrylate, lauryl methacrylate, stearyl acrylate and stearyl methacrylate.

18. The process of claim 17 wherein the reaction is carried out above ambient temperature.

19. The process of claim 18 wherein the free radical initiator is an azo type initiator.

20. The process of claim 19 wherein the multifunctional thio compound, monomer, and free radical initiator are added continuously to the reaction vessel.

21. A star-branched anionic polymer prepared in accordance with the process of claim 7, 8, 9, 10, 11, 12, 13, 14, 15, 16, 17, 18, 19, 20.

22. A calcium carbonate scale inhibitor comprising an effective scale inhibiting amount of the star-shaped polymer of claims 1, 2, 3, 4, 5, or 6.

23. A process for inhibiting the formation of calcium carbonate scale on a metal surface exposed to an aqueous system comprising:
adding an effective scale inhibiting amount of the star-shaped polymer of claims 1, 2, 3, 4, 5, or 6 to said aqueous system.

24. A pigment dispersion comprising water, a pigment, and an effective dispersing amount of the star-shaped polymer of claims 1, 2, 3, 4, 5, or 6.

25. A process for dispersing a pigment in an water comprising:
adding an effective dispersing amount of the star-shaped polymer of claims 1, 2, 3, 4, 5, or 6 to said aqueous system containing a pigment.
